(19) United States
(12) Patent Application Publication
(10) Pub. No.: US 2006/0161654 A1
(43) Pub. Date: Jul. 20, 2006

(54) Facilitating property management via an internet web site

(75) Inventors: Denver M. Hollingsworth JR., Wallace, NC (US); Roel Harsta, Bluffton, NC (US)

Correspondence Address: NIXON & VANDERHYE, PC, 901 NORTH GLEBE ROAD, 11TH FLOOR, ARLINGTON, VA, 22203, US

(73) Assignee: Epproach Communications, Bluffton, SC (US)

(21) Appl. No.: 11/332,372

(22) Filed: Jan. 17, 2006

Related U.S. Application Data
(60) Provisional application No. 60/643,594, filed on Jan. 14, 2005.

(51) Int. Cl. G06F 15/16; G06F 15/173

(52) U.S. Cl. 709/224; 709/217

(57) ABSTRACT

A system and method facilitate property management via an Internet web site. A property address is linked to the Internet web site via a Uniform Resource Locator (URL), where the URL includes at least a portion of the property address. A property management application is hosted via the Internet web site that enables tracking, management and storage of information, records and other activity associated with the property. The web site is a valuable addition to a property package enabling access to construction information, maintenance history, warranty information, etc.

### CROSS-REFERENCES TO RELATED APPLICATIONS

This application claims the benefit of U.S. Provisional Patent Application Ser. No. 60/643,594, filed Jan. 14, 2005, the entire content of which is herein incorporated by reference.

### STATEMENT REGARDING FEDERALLY SPONSORED RESEARCH OR DEVELOPMENT

(NOT APPLICABLE)

### BACKGROUND OF THE INVENTION

Epproach Communications provides broadband wireless Internet service and solutions for residential neighborhoods. The Company works with developers and homebuilders to install wireless networks that provide a cloud of broadband wireless coverage throughout the neighborhood. This cloud of wireless coverage provides wireless (WiFi), broadband Internet service to homeowners in their homes, outside on their property, in the clubhouse, at the pool, tennis courts and throughout the neighborhood. The cloud of wireless connectivity can also be used to connect devices such as wireless cameras.

Epproach provides broadband wireless networks and high speed Internet service to all the homeowners in the neighborhood. The developers and builders pay for the initial installation of the wireless network to include the wireless capabilities as a high tech amenity for the neighborhoods. The ongoing Internet service may be included in the homeowner's association fees or purchased directly by the homeowners.

The system includes broadband Internet service with email, web hosting and other support typically associated with Internet Service Providers. The system also supports high speed connectivity for builders and contractors while the neighborhood is being built. The cloud of connectivity provides very high speed data transmissions and supports wireless cameras and other applications that require high bandwidth. The system includes the ability to use the high speed cloud to connect homeowners to the Internet and incorporate other features such as streaming video from wireless cameras.

The system will provide a layer of wireless broadband communications that will allow residents, guests, transient service providers and others that are in the neighborhood have high speed Internet access. This communications layer can be used to link service providers and others to the residents of the neighborhood. The wireless broadband layer may additionally be linked to Voice Over IP systems to provide another layer of Voice communications as well.

### BRIEF SUMMARY OF THE INVENTION

Epproach Communications has expanded their solutions by creating and offering a unique solution that incorporates a proprietary methodology of naming and hosting web sites which utilize proprietary software applications and associated services for home (residential properties) and commercial property owners. Each home and/or property and owner is assigned a unique URL (Web Site) that corresponds to the physical address of the property. For example, a home being built or located at the physical address of 123 Elm Street in the zip code area of 28466 may be assigned a URL of www.123elmstreet28466.com or www.123elmstreet28466.eh411.com. The physical address of the home or property will be incorporated into the URL naming protocol. This URL will become the web site for the property and home. The web site will host a proprietary application designed to allow a homeowner or property owner to track, manage and store all information, records and other activity associated with the construction and ownership of their home or property. The methodology of linking a physical property and physical address to a web site (URL) and the functionality of the software application creates a unique solution.

In an exemplary embodiment of the invention, a method of facilitating property management via an Internet web site includes the steps of linking a property address to the Internet web site via a Uniform Resource Locator (URL), where the URL includes at least a portion of the property address; and hosting via the Internet web site a property management application that enables tracking, management and storage of information, records and other activity associated with the property. The linking step may be practiced by incorporating at least one of a number, a street name and a zip code of the property address in the URL.

In one arrangement, the hosting step is practiced by executing the property management application to generate communications to a user relating to management of the property. The generating step may be practiced by generating advertisements relating to a user inquiry via the web site of the information, records and other activity associated with the property. Alternatively or additionally, the generating step may be practiced according to a time-based schedule stored via the Internet web site, e.g., to signal an identification of property items due for maintenance, service, repair or other activities associated with the property. In this context, the generating step may further include a step of generating advertisements or advertiser links for products or services relating to the identified property items. The method may enable the user to document when the maintenance, service, repair or other activity has been completed and archive this information via the property management application for future reference.

The property management application may additionally include a transaction or searching module, where the hosting step comprises periodically accessing the Internet (e.g., searching or the like) via the transaction module for products and services relevant to the property and generating communications to a user concerning available products and services. The method may further include designating the Internet web site as a part of the property. The hosting step preferably further includes storing and enabling access to streaming video files relating to the property. Other features may include the hosting step including locking a selected portion of the information, records and other activity associated with the property, thereby making the selected portion a permanent record of the property; the linking step including assigning an e-mail address to the web site, the e-mail address including at least a portion of the property address; and the hosting step including executing the property management application and generating advertising communications to target audiences based on the portion of the property address in the URL.

In another exemplary embodiment of the invention, a method is provided for facilitating property management via an Internet web site where the property resides in an area covered by neighborhood-wide wireless Internet accessibility. The method includes the steps of linking a property address to the Internet web site via a Uniform Resource Locator (URL), the URL including at least a portion of the property address; hosting via the Internet web site a property management application that enables tracking, management and storage of information, records and other activity associated with the property; and accessing the Internet web site via the neighborhood-wide wireless Internet accessibility. In this context, the property management application may be provided with a service availability module that receives a communication from a service provider via the neighborhood-wide wireless Internet accessibility that the service provider is available, where the hosting step is practiced by executing the property management application. The executing step includes generating a communication via the Internet web site to a user relating to availability of the service provider.

In yet another exemplary embodiment of the invention, a method linking a property address to an Internet web site includes the steps of establishing the Internet web site; storing information, records and other activity associated with the property address; and defining a Uniform Resource Locator (URL) for access to the Internet web site via the Internet, the URL including at least a portion of the property address.

In still another exemplary embodiment of the invention, a computer system facilitates property management via an Internet web site. The computer system includes a system server running a server program including a property management application that enables tracking, management and storage of information, records and other activity associated with the property. At least one user computer, which runs an appropriate computer program, and the system server are interconnected by a computer network. The computer program accesses and requests information from the system server via a Uniform Resource Locator (URL), where the URL includes at least a portion of the property address.

### BRIEF DESCRIPTION OF THE DRAWINGS

These and other aspects and advantages of the present invention will be described in detail with reference to the accompanying drawings, in which:

FIG. 1 is a schematic block diagram of a computer system suitable for use as the client and server components of the property management system and method of the present invention; and

FIG. 2 is schematic illustration of a neighborhood incorporating the system and method of the invention.

### DETAILED DESCRIPTION OF THE INVENTION

The web model implementing the system of the invention is preferably a three-tier web-based application. The user browser requests information from a web server. The web server sends the requested data from a database server back to the browser client and the browser client then interprets and displays the data on the user's computer screen. The process is as follows:

1. The user runs a web browser program on his/her computer.

2. The user connects to the web server computer (e.g., via the Internet). Connection to the web server computer may be conditioned upon the correct entry of a password as is well known.

3. The user requests a page from the web server computer. The user's browser sends a message to the server computer that includes the following:
the transfer protocol (e.g., http://); and
the address, or Uniform Resource Locator (URL).

4. The web server computer receives the user's request and retrieves the requested page, which is composed, for example, in HTML (Hypertext Markup Language) and ASP or JSP forms, etc.

5. The server then transmits the requested page to the user's computer.

6. The user's browser program receives the HTML text and displays its interpretation of the requested page.

Thus, the browser program on the user's computer sends requests and receives the data needed to display the HTML page on the user's computer screen. This includes the HTML file itself plus any graphic, sound and/or video files mentioned in it. Once the data is retrieved, the browser formats the data and displays the data on the user's computer screen. Helper applications, plug-ins, and enhancements such as Java enable the browser, among other things, to play sound and/or display video inserted in the HTML file. The fonts installed on the user's computer and the display preferences in the browser used by the user determine how the text is formatted.

If the user has requested an action that requires running a program (e.g., a search), the web server loads and runs the program. This process usually creates a dynamic HTML page “on the fly” that contains the results of the program's action (e.g., the search results), and then sends those results back to the browser.

Browser programs suitable for use in connection with the account management system of the present invention include Netscape® Navigator available from Netscape® Communications Corporation and Internet Explorer available from Microsoft® Corp.

While the above description contemplates that each user has a computer running a web browser, it will be appreciated that more than one user could use a particular computer terminal or that a “kiosk” at a central location (e.g., a cafeteria, a break area, etc.) with access to the web server could be provided.

It will be recognized by those in the art that various tools are readily available to create web pages for accessing data stored on a server and that such tools may be used to develop and implement the property management system described below and illustrated in the accompanying drawings.

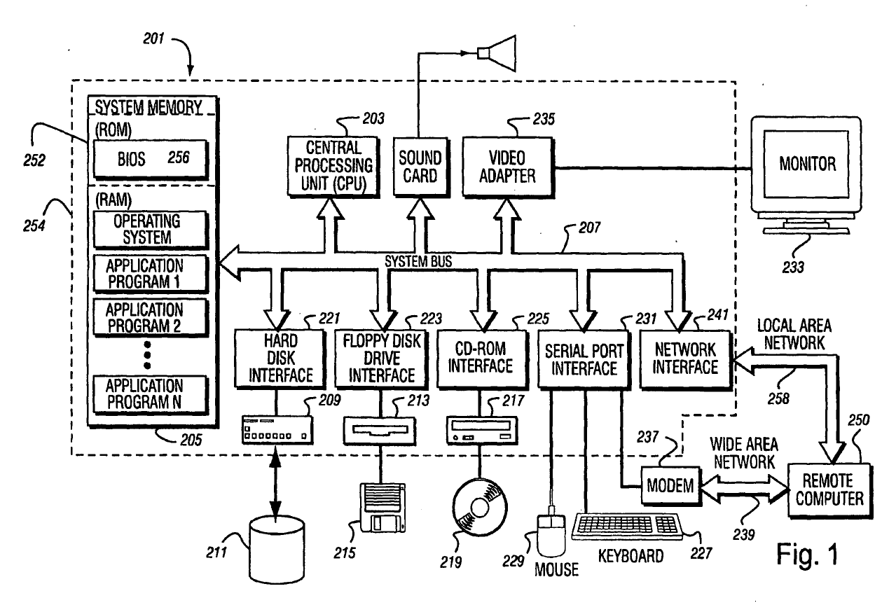

FIG. 1 generally illustrates a computer system 201 suitable for use as the client and server components of the property management system. It will be appreciated that the client and server computers will run appropriate software and that the client and server computers may be somewhat differently configured with respect to the processing power of their respective processors and with respect to the amount of memory used. Computer system 201 includes a processing unit 203 and a system memory 205. A system bus 207 couples various system components including system memory 205 to processing unit 203. System bus 207 may be any of several types of bus structures including a memory bus or memory controller, a peripheral bus, and a local bus using any of a variety of bus architectures. System memory 205 includes read only memory (ROM) 252 and random access memory (RAM) 254. A basic input/output system (BIOS) 256, containing the basic routines that help to transfer information between elements within computer system 201, such as during start-up, is stored in ROM 252. Computer system 201 further includes various drives and associated computer-readable media. A hard disk drive 209 reads from and writes to a (typically fixed) magnetic hard disk 211; a magnetic disk drive 213 reads from and writes to a removable “floppy” or other magnetic disk 215; and an optical disk drive 217 reads from and, in some configurations, writes to a removable optical disk 219 such as a CD ROM or other optical media. Hard disk drive 209, magnetic disk drive 213, and optical disk drive 217 are connected to system bus 207 by a hard disk drive interface 221, a magnetic disk drive interface 223, and an optical drive interface 225, respectively. The drives and their associated computer-readable media provide nonvolatile storage of computer-readable instructions, SQL-based procedures, data structures, program modules, and other data for computer system 201. In other configurations, other types of computer-readable media that can store data that is accessible by a computer (e.g., magnetic cassettes, flash memory cards, digital video disks, Bernoulli cartridges, random access memories (RAMs), read only memories (ROMs) and the like) may also be used.

A number of program modules may be stored on the hard disk 211, removable magnetic disk 215, optical disk 219 and/or ROM 252 and/or RAM 254 of the system memory 205. Such program modules may include an operating system providing graphics and sound APIs, one or more application programs, other program modules, and program data. A user may enter commands and information into computer system 201 through input devices such as a keyboard 227 and a pointing device 229. Other input devices may include a microphone, joystick, game controller, satellite dish, scanner, or the like. These and other input devices are often connected to the processing unit 203 through a serial port interface 231 that is coupled to the system bus 207, but may be connected by other interfaces, such as a parallel port interface or a universal serial bus (USB). A monitor 233 or other type of display device is also connected to system bus 207 via an interface, such as a video adapter 235.

The computer system 201 may also include a modem 237 or other means for establishing communications over the wide area network 239, such as the Internet. The modem 237, which may be internal or external, is connected to the system bus 207 via the serial port interface 231. A network interface 241 may also be provided for allowing the computer system 201 to communicate with a remote computing device 250 via a local area network 258 (or such communication may be via the wide area network 239 or other communications path such as dial-up or other communications means). The computer system 201 will typically include other peripheral output devices, such as printers and other standard peripheral devices.

As will be understood by those familiar with web-based forms and screens, users may make menu selections by pointing-and-clicking using a mouse, trackball or other pointing device, or by using the TAB and ENTER keys on a keyboard. For example, menu selections may be highlighted by positioning the cursor on the selections using a mouse or by using the TAB key. The mouse may be left-clicked to select the selection or the ENTER key may be pressed. Other selection mechanisms including voice-recognition systems, touch-sensitive screens, etc. may be used, and the invention is not limited in this respect.

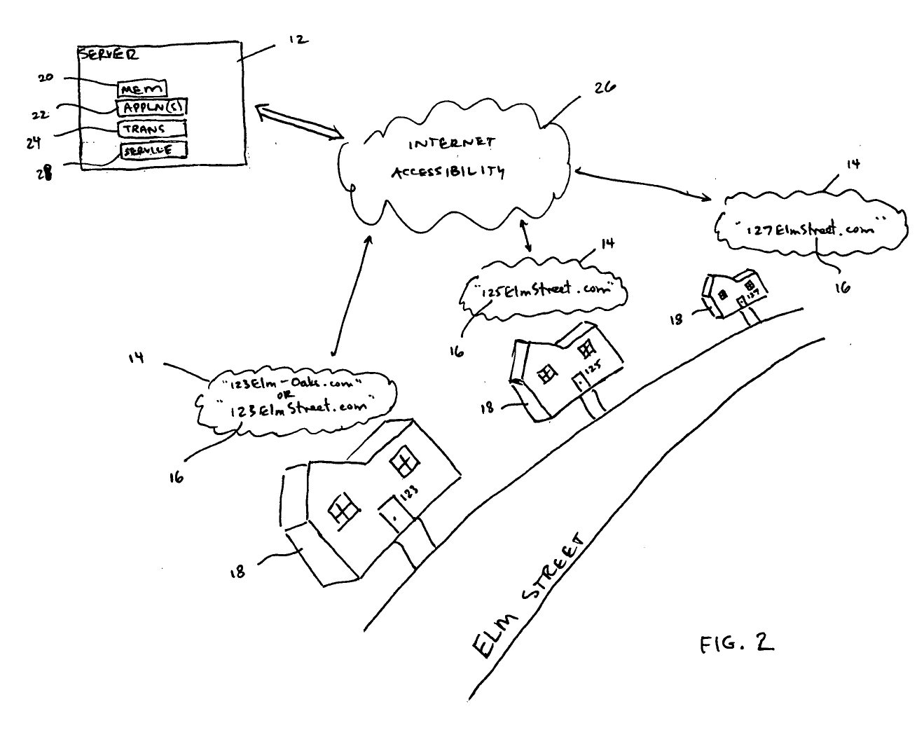

FIG. 2 is a schematic illustration of a neighborhood incorporating the property management system of the invention. Through an Internet-accessed server 12, the application and information is hosted and permanently stored via a memory 20 at a web site 14 that is uniquely identified by a URL 16 that corresponds with the physical address of the property 18. The web site 14 is designed for the property and hosted at a site that is unique to the property. The web site 14 becomes a virtual component of the property 18 and transfers with the ownership of the property. Much like a structure, a pool, an easement or other components that make up the whole of your property, the system remains a part of the property when it is sold or is transferred to new owners. The physical property geographically located at a specific address is explicitly linked to a URL and web site by incorporating the physical address in the URL of the web site and application.

The system application 22 executed by the server 12 is specifically designed with unique functionality to serve the property and the structure(s) located on the property. The application allows all details and documentation related to the property and structures on the property to be captured and stored online in a permanent manner via memory 20 and in the unique location or URL created by the system naming and storage methodology. Information related to the property, stored in this manner is used in the application to provide the owner quick and easy access to information and documentation related to the property, the ability to establish and pre-schedule automatic reminders and prompts for maintenance or management activities related to any component of the property and the ability to configure and pre-schedule Internet searches and/or activities associated with any component of the property. Furthermore, the system provides the administrator of the application the ability to connect advertising messages and/or web links that are specifically associated with specific components of the property and/or specific automatic reminders and prompts and/or specific pre-scheduled Internet searches and/or activities.

### EXAMPLES

A property owner can go their unique web site and get the exact dimensions of the lot, the building plans for the structure, the serial number for the appliances used, the manufacturer of the carpet, shingles or other materials, the sub-contractors used in the construction, and any other information related to the property.

The property owner can go to their unique web site and see streaming video of the physical site, the construction of the home or other buildings or any other aspect of the site that is included in the camera shots.

One or more web-based applications 22 may be stored and operating at this unique web address that includes various functions, including without limitation: the ability to capture and store details, including files, images, videos, etc about any component of the property; the ability to retrieve this information from the web site very easily; the ability to secure and password protect any component of the web site; the ability to “lock” a record or data and make it a permanent record; the ability to associate advertisements or other links or information to specific components of the site; the ability to assign an email address to the site that is specific to the property and not an individual, e.g., propertyowner@ 123elmstreet.com; the ability to link the specific property and specific components of the property to an automated functionality for pre-scheduling activities related to the property and its components; and the like. This in turn will provide the user with automated prompts and notifications via email and internally in the application when the pre-scheduled activities are due.

The property owner may elect to pre-schedule maintenance on mechanical system, such as the heating and air units once per year; or pre-schedule carpet cleaning once per year; or any other maintenance or related activities for any component of the property.

When these prompts or notifications are delivered to the user, the user may indicate when the activities are completed, and the completion of the activity becomes a permanent historical record associated with the property or the component of the property.

When a prompt or notification is delivered to the user, the application supports the attachment of online advertising and/or e-commerce links. A link for materials or services related to the specific prompt or notification may be attached to the notification. When the user gets the notification for the specific component of the property, they will also get an advertisement or e-commerce link associated with the type of component, material or service for which they have set a pre-scheduled notification. This concept can be extended where online advertising may be specifically associated with a component of the site so that advertising related to the component is delivered whenever the user accesses the web site to inquire about a property component.

This is a novel methodology for delivering advertising and e-commerce. The user or target of the advertising is inquiring about a specific component or pre-scheduling a specific event related to their property; at the precise time the event is scheduled to occur, the user will get advertising specifically related to the task and/or components or materials of the property. Creating this link between the physical property and activities related to the specific components of the property at the precise time the an inquiry is made or activities are scheduled to occur and the entities that provide services and materials specifically for the property component and the scheduled task, is a distinctively unique functionality of system.

This functionality will allow advertisers and providers to reach a very defined target audience at the precise time the audience is in need of their products and/or services.

The novel web site/URL naming methodology of system will allow audiences to be targeted by zip code (addresses), and the data stored within the system application can be used to further define and narrow the audience to allow the system to deliver a specific advertisement/e-commerce opportunity at the most opportune time. It will be delivered exactly when the event is scheduled and exactly when the user is in need of the products and services. The system will further allow the user to select one or more of the advertisements and correspond directly with the provider to order products or services or get more information Moreover, the system may facilitate automated ordering and scheduling of the delivery of these products and/or services.

In an exemplary application, the user sets a notification for cleaning the carpets of their property once per year. When the notification is delivered to the user, it will have advertisements associated with the notification from providers of carpet cleaning services. The application can be configured to select one or more of these providers and solicit proposals, then select the most advantageous proposal and place an order for carpet cleaning services. Once the services are complete, the service provider can be required to submit a completion form online that will update the system data and record the completion of the service.

The system application also provides the ability to link the specific property and specific components of the property to an automated functionality that allows the user to configure and pre-schedule automatic activities such as Internet searches and Internet transactions associated with the specific property or components of the property.

The application will garnish data from the web site about specific components of the property and (based upon configuration options by the user) automatically initiate Internet-based activities related to the specific data and component of the property.

In an exemplary application, the system may extract the square footage of the home, number of bedrooms, baths, and other details about the home and the zip code of the home and conduct an online search and evaluation to determine the approximate appraisal value of the home.

The system may extract the make, model and manufacturer of an appliance and automatically conduct a search or other transaction via a transaction module 24 of an auction venue such as eBay for the availability and price of accessories related to the appliance. Or, the system may automatically promote the sale of an appliance on the action site based upon configuration. The results would be automatically returned to the user and allow the user to interact with the results.

Other examples would be automatic searches on Google or other search engines or general internet transactions for materials or supplies related to the specific component of the property or the solicitation of online bids or proposals for materials and services related to the property. The information can be automatically gathered and presented to the user based upon configuration options. Advertising and e-commerce links may be associated with these returned results and provide interactive options for the user.

When these activities are completed, the user will get prompts or notifications that provide the user the results of the activities and allow the user to interact with returned results. The completion of the activity becomes a record associated with the property or component of the property.

This is a novel methodology for allowing properties and their owners and information related to specific components of the property to interact with the Internet. The system will proactively and automatically derive information from the property and its components and conduct online activities. Each component of the property will have specific data elements associated with the property. The application will have functionality that allows a user to select these elements and configure a file (such as an XML file) from these elements. The application will have functionality that causes the file to be automatically entered into the screens or fields of online search engines and other online applications. The functionality will further cause the associated online applications to execute a search or transaction the results of which will be captured into the property management application. The results will then be presented to the user. Creating this link between the physical property and the specific components of the property with online Internet tools and applications is a distinctively novel functionality of the system.

The system concept and application may be coupled with a wireless broadband network 26 that covers the specific community or neighborhood. When the system is coupled with the network program, the application will offer the additional ability of allowing vendors and service providers to interact with the system application and the property owners in real time via a service module 28 by utilizing the wireless network 26. The system can provide the user information about a service, and the user may select the service provider and the service provider would be immediately notified via the wireless network. By allowing this real time interaction, the property owner and the service providers both benefit.

In an exemplary application, the system will prompt the home owner(s) to indicate whether they want to be notified when a service provider is in the local area and available to provide their services. The service provider can indicate on a wireless device when they are in the area via the service module 28. For example, a carpet cleaner may indicate they are in the neighborhood and may be willing to offer a discount if they can find another job that same day. This information would be provided to the home owner, and the home owner could immediately elect to get the service on that day, in real time and receive a discount on the service. This information will be delivered immediately to the service provider via the neighborhood wireless network 26.

This is a novel methodology for linking properties and their owners and information related to specific components of the property to service and material providers via a wireless network. The application will proactively and automatically derive information from the property and its components and information from service and material providers and allow for two-way, real time communications over the neighborhood wireless network to facilitate the delivery of services or materials.

A company can offer services for capturing the data associated with the property and for configuring the functionality associated with the application.

A neighborhood component is an additional component of the system solution that is similarly a hosted web site and application. The neighborhood component is designed to provide information, communication and branding capabilities for the neighborhood or development. This component of the system solution will be hosted at a unique URL that corresponds to the name of the development and provides a common shared solution for all the residents in the neighborhood. The neighborhood component provides an interactive site for the Developer, Homeowner Association or Property Management Company to establish a branded site and communication solution for the neighborhood. Like the core system, the neighborhood component adds a valuable amenity to the entire neighborhood and consequently to all property owners. Like the streets, lampposts, landscaping, front gate and other physical infrastructure that constitute a neighborhood, the neighborhood component solution ultimately identifies the personality of the community and contributes to the lifestyle of all the residents. Combined with the program, the neighborhood component creates a novel solution.

The system solution is targeted at the property owner, homebuyer and homeowner. Unlike other software applications designed to automate a builder's activities and business, the system is designed to add value to the property and ultimately benefit the property owner and the builder. The property owner will gain a valuable component to their property, and the builder will gain a valuable amenity and feature that can be used to differentiate their properties and better serve their constituents.

The system provides an interactive, online, secure and permanent record of all the information and activity that is a part of building and owning a home. It allows the user (builder, homeowner, etc.) to easily and in some cases automatically record and store information related to the property and/or the construction and maintenance of the home, buildings or other structures on the property via a web site that is uniquely, yet easily identified on the world wide web including the same address as the physical address of the property. The builder and homeowner can collaborate and better manage the construction phase, and the homeowner can much more easily manage ongoing maintenance by having readily available access to all the information about the property.

The system is structured to allow easy implementation and for easy use. It is designed to allow anyone to use it with no training. The system can be customized to fit a specific neighborhood and home. The system may include the following exemplary structured features, without limitation, for recording and managing the details of home construction and ownership (in addition to these structured features, the system provides the flexibility to customize the solution to fit a specific geography, culture or other specific requirements):

Messaging and Collaboration
Builder and Owner Can Send and Receive Messages
Auto Notifications
Timed Reminders to Complete a Task
etc

Video and/or Images of the Home and Property
Streaming Video of the Site
Watch the Home Being Built
Store Images
Replay “Time Delayed” Construction of the Home
Video or Images of Other Sites of Interest in the Neighborhood
   Tennis
   Pool
   etc
Convert Video to Home Security and Communication tools after the construction phase

Proactive Maintenance Scheduling
User Defined Maint. Schedules
Linked to Specific Manfacturers
Automatic Alerts and Notifications
Record and Store Maint. Details and History
etc

Home Information
Builder and other Associated Contracts
Property Deed and Associated docs.
Lot Plans and Details
   Size and Dimensions
   Identification Details
   Landscaping Details
   Other Information Related to the Lot
House Plans and Details
   Size and Dimensions
   Electrical
   Plumbing
   HVAC
   Structural Details
      Interior
      Exterior
   Other
Warranties
   All Warranties Stored Online
Appliances
   Manufacturer Info
   Warranties
Additional Categories may be defined as required to capture all information about the property

Community Information
Home Owner Association Info
   Covenants, Rules, HOA Fee Structure, etc.
   Messages
   Collaboration Tools
Facilities Info
   Tee Times
   Tennis Court Schedules
   Clubhouse Events
   Etc.
Bulletin Boards
   Baby Sitting
   Yard Sales
   Etc.

Finance Info
Closing Documents
Appraisals
Mortgage Info
Insurance
Tax Information
Etc

Services
Pest Control
Landscaping
Moving
Cleaning
Etc.

Contacts and Other Misc. Info

How to Guides

Turn the Water On
Turn the Power Off
Check the Roof
Etc.
   Where is it Guides
Water Meter
Power Shut Off
Etc.
   Account Tools
Pay Bills Online
Order Services
Etc.
   Administrative Tools
Manage Your Account
Set up Passwords
Set Up Links
etc

The system provides developers and builders with an exciting new benefit to offer their customers. It allows the builder to integrate a product into their overall delivery that adds significant value during the construction phase by providing a communications tool that will benefit both the home buyer and the builder. By establishing an interactive web site for the property and utilizing the system solution, the builder can keep the buyer better informed and eliminate missed deadlines, misunderstandings and miscommunications. Perhaps even more important, the builder can add a virtual component to the home and property that, much like the quality built home, will stand the test of time and become even more valuable as time goes on. The system becomes a part of the property and provides the homeowner with another enhanced upgrade that will benefit them throughout the ownership of the home and add value at the time of re-sale. The system provides a positive return on investment to both the builder and homeowner.

Advertising Fees and Revenues

For a fee advertisers can access the information database of the homes system application. This application will contain information such as geographic location (zip code, street address, income area, etc.), size (sq ft, number of bedrooms, etc.), value (appraisal or last sale price) and state of residency (for sale, unoccupied, repossessed etc). Mortgage companies, refinance companies, home insurance companies and the like would be able to target the customer in ways not possible before. Zip code information can be combined with home information. For example, the insurance company has information stating that a home was insured in 2003 for $250,000, and the value of the homes in zip code 67417 today has risen 20% since then. The system can be configured to display this information and a message “Click here to update your insurance,” with a link to an insurance company.

The system is designed to serve the overall community. It will provide the community with a functional web site branded to enhance the image and appeal of the community. It will provide tools and functionality for the Developer, Homeowner Association (HOA), residents and other entities that interact and serve the community.

Value Proposition

The system enhances the image and appeal of the community by adding an amenity that elevates the lifestyle of the residents and increases the value of all properties in the community. This allows the developer, builders and ultimately property and homeowners to more easily build value in the sell and/or re-sell their properties.

Exemplary Objectives

1. Provide a web site template for easily setting up a page for the overall community.
2. Host this page at the name of the community with the zip code to make the URL unique. Ex. www.Enclave28466.com
3. Provide a way to embed a logo or image to “brand” the neighborhood.
4. Create other graphics and images to enhance the appearance and appeal of the community.
5. Provide a bulletin board to allow the user to post messages and or links.
6. Provide a “News” section to allow users to post news or current events.
7. Provide an illustrated map of the neighborhood (like they do in the brochures).
8. Allow a user to click on the map, on a specific lot, and then be directed to the web site of the specific home.
9. Provide an area that includes the marketing copy for the neighborhood (like they do in the brochures).
10. Provide a “Safety and Security” section that includes all the information about:
   a. Local Public Safety contacts, etc
   b. Any local procedures or protocols for hurricanes, earthquakes, other natural disasters, etc
   c. Local information for reporting crime, etc.
   d. Local Police Chief, Fire Chief, Location of firehouses, police depts., etc
   e. Contact information for any crime watch, victims advocates, shelters or other support organizations.
11. Information on the gates and associated entry rules (if it is a gated community).
12. Provide a location for HOA covenants, etc.
13. Provide a location for HOA officers with contact info.
14. Provide a space for HOT items for HOA consideration.
15. Provide a space for the Architecture Review Board (ARB) rules and comments, etc.
16. Provide a space for linking in Cameras that may be placed throughout the neighborhood.
17. Allow the user to pick a camera and view the streaming video from that camera
18. Provide a baby sitter selection site. Include schedules of the baby sitters and allow the user to pick a sitter online.
19. Provide a Yard Sale template to allow yard sales to be posted and allow the user to link in a video camera of the yard sale.
20. Provide a template for posting schedules for the clubhouse.
21. Provide a template for posting menus from clubhouse restaurants, snack bars, etc.
22. Provide a gaming area where garners can go online to find others in the neighborhood that want to compete in games online.
23. Provide an area to link in the security cameras from the gates in gated communities.
24. Provide a way to do on-line surveys or voting. This will allow the HOA to conduct on-line elections, voting or surveys.
25. Provide a way of doing streaming video of HOA meetings or other events that might be appropriate to the community.
26. Provide streaming video feeds from the common facilities—tennis courts, pool, golf course, etc.
27. Provide a template for linking in golf course information—to be provided by the golf course management.
28. Provide a template and model to allow businesses that want to reach the community to post advertisements or interactive links to their services.
29. Provide a forum section that can be categorized by subject.

Each home will ultimately have a physical mailing address and a virtual web address. For example, a home located at 123 Elm Street will have a corresponding web site located at www.123elmstreetzipcode.com (or, using a common server, www.123elmstreetzipcode.epproach.com) or the like (see FIG. 2). This unique web address will always be available to track, manage and store all the many transactions, information and data that ultimately make up a home or property. This universally recognized information management technique will prove to be invaluable to the homeowner while they are living in and managing the home, and it will become an invaluable amenity that transfers with the home and adds significant value to the property.

While the invention has been described in connection with what is presently considered to be the most practical and preferred embodiments, it is to be understood that the invention is not to be limited to the disclosed embodiments, but on the contrary, is intended to cover various modifications and equivalent arrangements included within the spirit and scope of the appended claims.

1. A method of facilitating property management via an Internet web site, the method comprising:
linking a property address to the Internet web site via a Uniform Resource Locator (URL), the URL including at least a portion of the property address; and
hosting via the Internet web site a property management application that enables tracking, management and storage of information, records and other activity associated with the property.

2. A method according to claim 1, wherein the linking step is practiced by incorporating at least one of a number, a street name, and a zip code of the property address in the URL.

3. A method according to claim 1, wherein the hosting step is practiced by executing the property management application, the executing step comprising generating communications to a user relating to management of the property.

4. A method according to claim 3, wherein the generating step is practiced according to a time-based schedule stored via the Internet web site.

5. A method according to claim 3, wherein the generating step is practiced by generating advertisements relating to a user inquiry via the web site of the information, records and other activity associated with the property.

6. A method according to claim 5, wherein the generating step comprises generating communications to the user that identify property items due for maintenance, service, repair or other activity associated with the property items.

7. A method according to claim 6, wherein the generating step further comprises generating advertisements or advertiser links for products or services relating to the identified property items.

8. A method according to claim 6, further comprising enabling the user to document when the maintenance, service, repair, or other activity has been completed, and archiving this information via the property management application for future reference.

9. A method according to claim 1, wherein the property management application includes a transaction module, and wherein the hosting step comprises periodically accessing the Internet via the transaction module for products, services or other items relevant to the property and generating communications to a user concerning the available products, services and other items.

10. A method according to claim 1, further comprising designating the Internet web site as a part of the property.

11. A method according to claim 1, wherein the hosting step further comprises storing and enabling access to streaming video files relating to the property.

12. A method according to claim 1, wherein the hosting step comprises locking a selected portion of the information, records and other activity associated with the property, thereby making the selected portion a permanent record of the property.

13. A method according to claim 1, wherein the linking step comprises assigning an e-mail address to the web site, the e-mail address including at least a portion of the property address.

14. A method according to claim 1, wherein the hosting step is practiced by executing the property management application, the executing step comprising generating advertising communications to target audiences based on the portion of the property address in the URL.

15. A method of facilitating property management via an Internet web site, the property residing in an area covered by neighborhood-wide wireless Internet accessibility, the method comprising:
linking a property address to the Internet web site via a Uniform Resource Locator (URL), the URL including at least a portion of the property address;
hosting via the Internet web site a property management application that enables tracking, management and storage of information, records and other activity associated with the property; and
accessing the Internet web site via the neighborhood-wide wireless Internet accessibility.

16. A method according to claim 15, wherein the property management application comprises a service availability module that receives a communication from a service provider via the neighborhood-wide wireless Internet accessibility that the service provider is available, and wherein the hosting step is practiced by executing the property management application, the executing step comprising generating a communication via the Internet web site to a user relating to availability of the service provider.

17. A method linking a property address to an Internet web site comprising:
establishing the Internet web site;
storing information, records and other activity associated with the property address; and
defining a Uniform Resource Locator (URL) for access to the Internet web site via the Internet, the URL including at least a portion of the property address.

18. A method according to claim 17, wherein the defining step is practiced by incorporating at least one of a number, a street name, and a zip code of the property address in the URL.

19. A method according to claim 17, wherein the defining step is practiced by incorporating a development name in the URL.

20. A computer system for facilitating property management via an Internet web site, the computer system comprising:
a system server running a server program including a property management application that enables tracking, management and storage of information, records and other activity associated with the property; and
at least one user computer running a computer program, the at least one user computer and the system server being interconnected by a computer network, the computer program accessing and requesting information from the system server via a Uniform Resource Locator (URL), wherein the URL includes at least a portion of the property address.
